(19) United States
(12) Patent Application Publication
(10) Pub. No.: US 2011/0226943 A1
(43) Pub. Date: Sep. 22, 2011

(54) SATURATION CORRECTION FOR ION SIGNALS IN TIME-OF-FLIGHT MASS SPECTROMETERS

(76) Inventor: Oliver Räther, Lilienthal (DE)

(21) Appl. No.: 13/049,939

(22) Filed: Mar. 17, 2011

(30) Foreign Application Priority Data
Mar. 19, 2010 (DE) 10 2010 011 974.1

(51) Int. Cl. H01J 49/40

(52) U.S. Cl. 250/282

(57) ABSTRACT

A method for increasing a dynamic measurement range of a mass spectrometer, includes replacing measured values in saturation with correction values, and summing the correction values to provide a sum spectrum.

### PRIORITY INFORMATION

This patent application claims priority from German Patent Application 10 2010 011 974.1 filed on Mar. 19, 2010, which is hereby incorporated by reference.

### FIELD OF THE INVENTION

The present invention relates generally to mass spectrometry and, more particularly, to correcting an ion signal in saturation in a time-of-flight mass spectrometer.

### BACKGROUND OF THE INVENTION

A typical time-of-flight mass spectrometer acquires individual time-of-flight spectra in rapid succession. To avoid saturation effects for relatively intense ion signals, the spectra should include no more than a few hundred ions. The spectra therefore includes a large number of empty gaps and a strong variance. For low intensity ion signals, an ion is measured for every one in ten, one in one hundred or even one in one thousand individual time-of-flight spectra. Thousands of the individual time-of-flight spectra, which are acquired with scanning rates of up to ten thousand spectra per second or more, are subsequently processed into a sum spectrum. The sum spectrum may provide useful time-of-flight spectra with signals that are true to concentration across a large measurement range for ion species of the different substances being analyzed.

The term “ion signal” refers to a part of an ion current curve that includes ions of one charge-related mass m/z. This ion signal may also be referred to as an “ion peak”.

To measure the time-of-flight spectra, the ion currents are amplified by a factor of between ten to the fifth (10⁵) and ten to the seventh (10⁷) power using secondary electron multipliers (SEM), and subsequently sampled by special digitization units, which are referred to as “transient recorders”. The transient recorders include relatively fast analog-to-digital converters (ADC) that operate with sampling rates of, for example, approximately 4 gigasamples per second (GS/s); higher sampling rates of, for example, approximately 10 gigasamples per second are currently under development. The digitization depth per measurement is typically eight bits; i.e. it spans values from 0 to 255. A relatively good dynamic measurement range of five to six orders of magnitude therefore may be provided by summing hundreds or thousands of individual spectra.

A limited ion current may be used to prevent saturation of the analog-to-digital converter in the individual time-of-flight spectra. Each individual analyte ion, however, must be reliably measured. To prevent the loss of ions and saturation during the measurement, the amplification of the SEM should be accurately set. Examples of methods for optimally setting the amplification of the SEMs are disclosed in U.S. Publication No. 2009/0206247, which is hereby incorporated by reference in its entirety. It may be advantageous for an individual ion to produce a signal that generates a measured value of at least 2 to 3 counts in the ADC since the Poisson distribution of the secondary electrons is formed by an impacting ion. However, this limits the intensity dynamics in an individual time-of-flight spectrum to two orders of magnitude; e.g., from around 2.5 counts to 255 counts. Since there may be an electrical noise of up to three counts, the dynamic measuring range is even smaller; e.g., one and a half orders of magnitude.

The optimum setting of the secondary electron multiplier applies to ions of a selected charge-related mass m/z because the sensitivity of the SEM is dependent on mass and decreases roughly with 1/√(m/z). Where, for example, the amplification of an SEM is set such that a measured value of 2 to 3 counts is achieved for an ion having a charge-related mass of m/z=5,000 Daltons in order to prevent the loss of ions of high mass, a measured value of approximately 25 counts is achieved for an ion having a mass of m/z=50 Daltons, and the measurement range for ions of this mass is limited to one order of magnitude (e.g., from 25 to 255 counts). After taking the electric noise into account, a dynamic range of half an order of magnitude remains.

Until a few years ago the aforesaid limitation was not overly burdensome because the ion sources supplied limited quantities of ions per unit of time, and the transmission of the mass spectrometers was low enough such that saturation of the ADC was unlikely. This applied to both ion sources with ionization by electrospray ionization (ESI) and to ionization by matrix-assisted laser desorption (MALDI). Saturation is typically achieved, for example, where there are a few hundred ions in an ion signal of one mass because, as will be described below in further detail, the signal is distributed over at least eight measurement periods, where each period has a 0.25 nanosecond duration. However, 800 singly-charged ions per nanosecond may correspond to an ion current of approximately 5 nanoamperes, which is a relatively high ion current for the mass spectrometry of macromolecular substances. Due to the ongoing development of ion sources and mass spectrometers, however, the aforesaid saturation limit is being reached and exceeded more and more often. Methods that make it possible to approach or even exceed the saturation limit several times over therefore are needed in the art.

Secondary electron multipliers (SEM) may be used to measure the ion currents. The process of avalanche-type secondary electron multiplication, for example, may be used to amplify as well as broaden the electron current signal. From a single impacting ion, high quality secondary electron multipliers may generate a signal of approximately 0.5 nanoseconds full-width at half maximum. A signal width generated by less expensive secondary electron multipliers, in contrast, is approximately 1 to 2 nanoseconds.

Minimum signal widths at half height of approximately 0.5 nanoseconds for each individual ion, regardless of the mass of the ion, may be achieved by sampling the electron current curve from the SEMs point by point using a transient recorder with 8 gigasamples per second. Where the signal profiles of individual ions are summed in successive individual time-of-flight spectra, or where there are several ions of equal mass in an individual time-of-flight spectrum, the signal widths may be even larger. This is because focusing errors of the mass spectrometers, not fully compensated effects of initial energy distributions of the ions before their acceleration into the flight path, and other influences also play a part. These effects result in additional signal broadenings in the order of at least one nanosecond, where broadening is dependent on the mass of the ions. Since in our experience all these contributions add to the signal width in a Pythagorean way (i.e., they form the root of the added squares of the widths). Signal widths of approximately one nanosecond, at the minimum, therefore may be achieved with high quality spectrometers and detectors. In reality, however, the signal widths are typically in the range of 2 to 3 nanoseconds. Full-width at half maximum is typically constant in the lower mass range, where the avalanche width of the SEM dominates. In the upper mass range, on the other hand, the full-width at half maximum is approximately proportional to the square root of the charge-related mass m/z.

The aforesaid signal widths of the ion signals may limit the resolution of the time-of-flight mass spectrometers. While the generation of longer times of flight using lower accelerating voltages may increase resolution, lower accelerating voltages have other disadvantages. It may be preferable therefore to increase the length of the flight paths using longer flight tubes. The use of multiply bent flight paths with several reflectors to improve resolutions, however, has not proven to be a good solution. Alternatively, a tried and tested method for increasing resolution is to artificially increase of the time-of-flight resolution and mass resolution signal processing.

A computational improvement of the mass resolution may be performed via a signal analysis for each individual time-of-flight spectrum. Where an ion signal is found, a value that is proportional in terms of area or height is added only where the time-of-flight of the signal maximum is located. In the simplest case, only the measured value of the signal maximum is added at the relevant position of the signal maximum in the individual time-of-flight spectrum. Since the times of flight of the signal maximum are subject to statistical variations, a somewhat broader sum signal results for the ion signal. The sum signal has a finite width but is narrower than when each of the measured values is summed. The sum signal includes the statistical variances without the avalanche width or the width of the imaging errors. Such conditional additions are not easy to carry out, however, because the complete algorithm runs at four or even eight gigahertz, which is very difficult even when using relatively fast FPGA (field programmable gate arrays) or relatively fast digital signal processors (DSP).

This method not only increases the mass resolution, but also the mass accuracy. Adding together thousands of individual time-of-flight spectra produces a sum time-of-flight spectrum, which is referred to as “time-of-flight spectrum”. Mass spectra are computed from the time-of-flight spectra. The purpose of these time-of-flight mass spectrometers is to accurately determine the masses of the individual ionic species. The aforedescribed computational method that was initially introduced to increase the mass resolution, therefore, enables mass accuracies of approximately 0.5 ppm or better to be achieved in suitably designed mass spectrometers.

The term “ppm” (parts per million) refers to the relative accuracy of the mass determination in millionths of the charge-related mass m/z. The accuracy is, in turn, set statistically as sigma, the width parameter of the measurement variance, assuming a normal distribution. The width parameter gives the distance between the point of inflection and a maximum of a Gaussian normal distribution curve. For example, where the mass determination is repeated, 68% of the values are within the single sigma interval on both sides thereof (i.e., between the points of inflection), 95.57% in twice the sigma interval, 99.74% in three times the sigma interval and 99.9936% in four times the sigma interval of the normally distributed error spread curve. The aforesaid method of increasing the mass resolution and the mass accuracy, however, does not increase the dynamic measurement range. One still has to take care therefore not to drive the ion signals into saturation.

### SUMMARY OF THE INVENTION

According to one aspect of the invention, a method is provided for increasing a dynamic measurement range of a time-of-flight mass spectrometer. The method includes replacing measured values in saturation with correction values, and summing the correction values to provide a sum time-of-flight spectrum.

According to another aspect of the invention, a method is provided for increasing a measurement range of a mass spectrometer. The method includes determining a measured value of an ion signal in saturation, replacing the measured value with a correction value, and summing the correction value and a sum spectrum, where the sum spectrum comprises a summation of correction values.

According to still another aspect of the invention, a method is provided to increase a dynamic measurement range of a spectrum acquisition process. Measured values from an analog-to-digital converter (ADC), which are in saturation, may be replaced with correction values. The correction values may be added to provide a sum time-of-flight spectrum. The correction values may be derived from the width of the signals; e.g., from the number of measured values in saturation.

In one embodiment, a corrected value may be added at a time-of-flight position that corresponds to a center of a sequence of measured values in saturation. The corrected value may correspond to a statistically averaged true maximum measurement value at a given saturation width, and may be obtained from a table. The corrected value in the table may depend on the number of measured values in saturation and may additionally depend on the time-of-flight.

The table may be populated with corrected values provided from calibration measurements. The isotope patterns of organic substances are especially suitable for this because the high-intensity ion signals in saturation, which are not directly measurable, may be calculated from these substances' low-intensity isotope signals, which are still in the unsaturated measurement range. The statistical relationships between the true intensity maximum and the number of adjoining measured values in saturation therefore may be determined. The correction values may, however, also be calculated from accurate measurements of the signal shape in that part of the signal which is not in saturation.

These and other objects, features and advantages of the present invention will become more apparent in light of the following detailed description of preferred embodiments thereof, as illustrated in the accompanying figures.

### BRIEF DESCRIPTION OF THE DRAWINGS

FIG. 1 is a flow diagram that illustrates a method for increasing a dynamic measurement range of a time-of-flight mass spectrometer;

FIG. 2 graphically illustrates a statistical relationship between a true maximum of ion signals beyond a saturation value and a number of measurements in saturation;

FIGS. 3A and 3B graphically illustrate how a wide range of signal strengths may exist before a measured value in saturation becomes a sequence of two or more measured values in saturation; and

FIGS. 4A and 4B graphically illustrate an example of an isotope pattern of a peptide with a mass of 2000 atomic mass units.

### DETAILED DESCRIPTION OF THE INVENTION

A method for increasing a dynamic measurement range of a spectrum acquisition of a time-of-flight mass spectrometer is provided. Ion signals that drive an analog-to-digital converter (ADC) into saturation in an individual time-of-flight spectrum are replaced with correction values (also referred to as “corrected values”) where, for example, the saturation values extend over a plurality successive measurements. The correction values may be derived from a width of the ion signals; e.g., from a number of measured values in saturation. Since the signal forms may change as a function of the mass of the ions, the correction values may additionally depend on time-of-flight. The correction values may be stored in a memory device, for example in the foam of a table and arranged, for example, according to signal widths and time-of-flight ranges. The table may be populated with values obtained from relatively large numbers of calibration measurements or calculated using measured or calculated signal shapes for ions of equal mass.

This presupposes that an SEM (secondary electron multiplier) is adjusted in such a way, as described above, that a dynamic measurement range is increased to, for example, a maximum without losing individual ion signals.

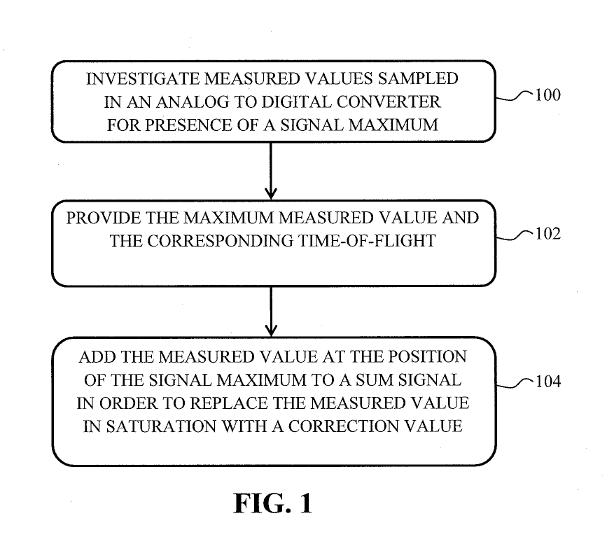

FIG. 1 illustrates an embodiment of the method for increasing the dynamic measurement range of the time-of-flight mass spectrometer. In step 100, measured values sampled in an ADC at a rate of, for example, eight gigasamples per second and with, for example, an eight bit depth are investigated with an FPGA (field programmable gate array) or a DSP (digital signal processor) for the presence of a signal maximum. In step 102, when a signal maximum is present, the maximum measured value and the corresponding time-of-flight, which has for example a counting index with at least a 24 bit depth, is communicated to an arithmetic unit. In step 104, the arithmetic unit adds the measured value at the position of the time-of-flight of the signal maximum to a sum spectrum. Since approximately one million values are measured in an individual time-of-flight spectrum and there are typically less than a few thousand ion signals, the arithmetic unit may also operate slower than the FPGA.

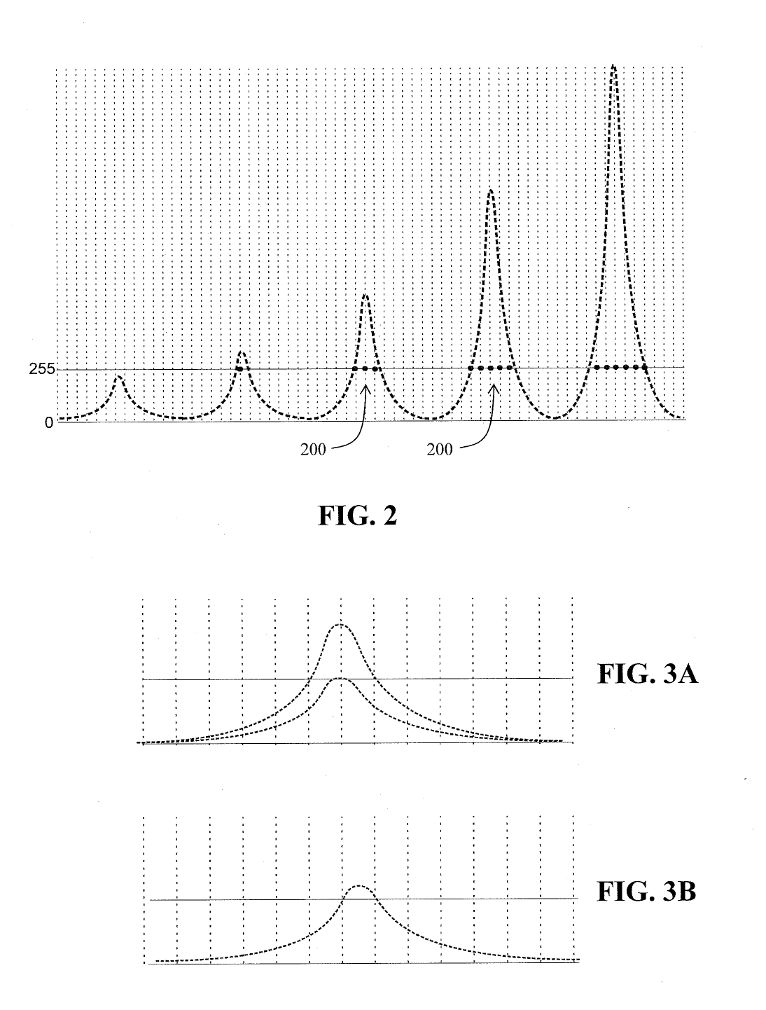

FIG. 2 graphically illustrates a statistical relationship between a true maximum of the ion signals beyond a saturation value of 255 and a number of measurements in saturation (see dots 200). When the search algorithm for signal maxima used in the FPGA determines, for example, that the saturation value 255 was transmitted by the ADC, the FPGA begins counting the measured values in saturation. When a measured value is no longer in saturation, the FPGA sends the time-of-flight index together with the number of measured values in saturation to the special arithmetic unit. FIGS. 3A and 3B graphically illustrate how a wide range of signal strengths may exist before the measured value in saturation becomes a sequence of two or more measured values in saturation. An approximate correction of the signal overshoots, therefore, may be provided after a relatively large number of corrections for ion signals of the same mass.

The arithmetic unit adds a corrected measurement value from a table to the sum spectrum at the position of the time-of-flight that corresponds to the center of the saturation range. The table may be structured, for example, according to the number of the saturated measured values and the time-of-flight ranges.

The table may be populated with table values for the corrections obtained by statistical averages from relatively large numbers of calibration measurements. The calibration measurements may be derived from, for example, the true signal intensities at the positions of saturation. Isotope patterns of organic substances may be used to determine the true signal intensities. The isotope patterns include signals with widely differing, but known intensities.

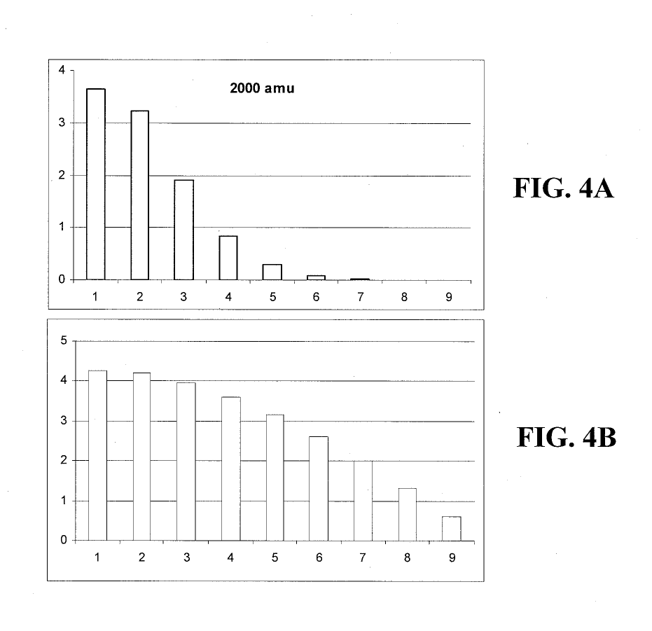

FIGS. 4A and 4B graphically illustrate an example of an isotope pattern of a peptide with a mass of 2000 atomic mass units. FIG. 4A illustrates the intensities of the isotope pattern in a linear mode. FIG. 4B illustrates the intensities of the isotope pattern logarithmically. The high-intensity ion signals beyond the saturation limit, which are not directly measurable, may be calculated from low-intensity isotope signals which are in the unsaturated measurement range. Where signals 1, 2, 3, and 4 are saturated in a measured spectrum, for example, their true height may be calculated from signals 5, 6, 7, and 8. The statistical relationships between intensity beyond the saturation and number of successive measured values in saturation may subsequently be determined. Each of the measurements is performed using a plurality of individual time-of-flight spectra. Using appropriate substances with different masses, which each supply relatively high ion currents, it is also possible to take measurements in different time-of-flight ranges. The calibration measurements may be performed automatically with suitable programs. The calibration measurements provide the above-mentioned tables with the correction values as a function of (i) the number of successive measured values in saturation and (ii) the time-of-flight range.

The corrected measured values from the table may not correspond, in individual cases, to the true intensity values of the ion signals. The statistical average of the corrected measured values over thousands of individual spectra, however, may provide a relatively good approximate value when the method is well calibrated. The method therefore may extend the dynamic range of measurement by, for example, two orders of magnitude or more. The method may also increase ion sensitivity by, for example, two orders of magnitude. This sensitivity increase is, of course, primarily brought about by improvement of the ion source and ion transmission in the mass spectrometer; but without the inventive method, it cannot be exploited with customary detection systems.

The method may be used when neighboring ion signals do not overlap in the saturation region. The time-of-flight mass spectrometer therefore should have a relatively good mass resolving power itself, e.g., without the computational improvement of the mass resolution. This is usually the case in the lower mass range where the extension of the dynamic measurement range is particularly useful.

A single correction value is added to the sum spectrum. Correction values, however, may alternatively be added at the times of flight of each of the measured values in saturation. The correction values may be obtained, as indicated above, by performing calibration measurements using isotope patterns, and stored in one or more tables. While the mass resolution may not increase using this alternative method, it may be possible to obtain more quantitatively accurate measurements.

Transient recorders are being developed not only to provide faster acquisition rates, but also to provide higher data depths for the analog-to-digital conversion. The aim is to achieve, for example, a 10 or even a 12-bit data depth. Even when the transient recorders are on the market, however, the problem with saturated measured values will soon reappear as a result of the continued development of ion sources with better yield and mass spectrometers with better transmission. It will continue to be advantageous therefore to replace saturated measurement values with correction values as described above.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A method for increasing a dynamic measurement range of a time-of-flight mass spectrometer, comprising:
replacing measured values in saturation with correction values; and
summing the correction values to provide a sum time-of-flight spectrum.

2. The method of claim 1, further comprising determining the correction values from a width of the ion signal in saturation.

3. The method of claim 1, further comprising determining the correction values from a number of the measured values of an ion signal in saturation.

4. The method of claim 3, where the correction values are stored in a memory device, and are arranged according to the number of the measured values.

5. The method of claim 1, further comprising determining the correction values from a number of the measured values of an ion signal in saturation and a time-of-flight of ions in the ion signal.

6. The method of claim 5, where the correction values are stored in a memory device, and are arranged according to the number of the measured values and ranges of the time-of-flight.

7. The method of claim 1, further comprising determining the correction values using measurements of isotope patterns of substance ions in individual time-of-flight spectra.

8. The method of claim 1, further comprising determining the correction values from one of a measured signal shape and an assumed signal shape.

9. The method of claim 1, where the summing of the correction values comprises adding each of the correction values at a respective time-of-flight to the sum time-of-flight spectrum for a plurality of the measured values.

10. The method of claim 9, where the adding of the correction values comprises adding the correction value at a time-of-flight of the sum time-of-flight spectrum that is approximately in a center of a saturation region.

11. The method of claim 1, where each correction value is divided between a plurality of time-of-flight values of the sum time-of-flight spectrum.

12. The method of claim 11, where the replacing the measured values comprises replacing each measurement value in saturation with a corresponding one of the correction values.

13. A method for increasing a measurement range of a mass spectrometer, comprising:
determining a measured value of an ion signal in saturation;
replacing the measured value with a correction value; and
adding the correction value to a sum spectrum, where the sum spectrum comprises a summation of correction values.

14. The method of claim 13, further comprising determining the correction value from a width of the ion signal in saturation.

15. The method of claim 13, further comprising determining the correction value from a number of measured values of an ion signal in saturation.

16. The method of claim 13, further comprising determining the correction value from a number of measured values of an ion signal in saturation and a time-of-flight of ions in the ion signal.

17. The method of claim 13, further comprising determining the correction value using measurements of isotope patterns of substance ions in individual time-of-flight spectra.

18. The method of claim 13, further comprising determining the correction value from one of a measured signal shape and an assumed signal shape.
